(19) United States
(12) Patent Application Publication
(10) Pub. No.: US 2009/0136289 A1
(43) Pub. Date: May 28, 2009

(54) Ball joint assembly

(75) Inventor: James R. Johnson, Lafayette, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/998,059

(22) Filed: Nov. 28, 2007

(51) Int. Cl. F16C 11/08

(52) U.S. Cl. 403/77

(57) ABSTRACT

The present invention relates to a ball joint assembly (10) including a housing (12) and a ball stud (72) disposed in the housing. The ball stud (72) has a head end portion (70) and a shank portion (74). A radial load bearing assembly (80) engages the shank portion (74) to support the ball stud (72) for movement relative to the housing (12).

### TECHNICAL FIELD

The present invention is directed to a ball joint assembly, and more specifically to a ball joint assembly having a radial load bearing assembly.

### BACKGROUND OF THE INVENTION

A ball joint assembly may be connected to a pitman or idler arm of a steering linkage for a vehicle. A typical ball joint assembly includes a housing and a ball stud. The ball stud includes a spherical head end portion disposed within the housing. A bearing member engages the head end portion to support the ball stud for movement relative to the housing.

### SUMMARY OF THE INVENTION

The present invention relates to a ball joint assembly including a housing and a ball stud disposed in the housing. The ball stud has a head end portion and a shank portion. A radial load bearing assembly engages the shank portion to support the ball stud for movement relative to the housing.

### BRIEF DESCRIPTION OF THE DRAWINGS

The foregoing features and advantages of the present invention will become apparent to those skilled in the art to which the present invention relates upon reading the following description with reference to the accompanying drawings, in which:

FIG. 1 is a perspective view of a ball joint assembly constructed in accordance with an exemplary embodiment of the invention;

FIG. 2 is an elevated side assembly view of the ball joint assembly of FIG. 1 attached to a frame of a vehicle;

FIG. 3 is a plan view of the ball joint assembly of FIG. 1;

FIG. 4 is a sectional view of the ball joint assembly of FIG. 3 taken along the line 4-4; and

FIG. 5 is a bottom plan view of the ball joint assembly of FIG. 1.

### DETAILED DESCRIPTION OF AN EXEMPLARY EMBODIMENT

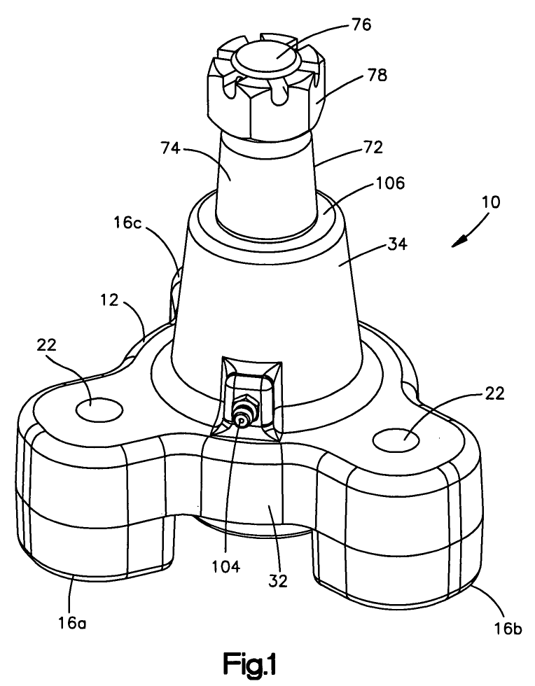

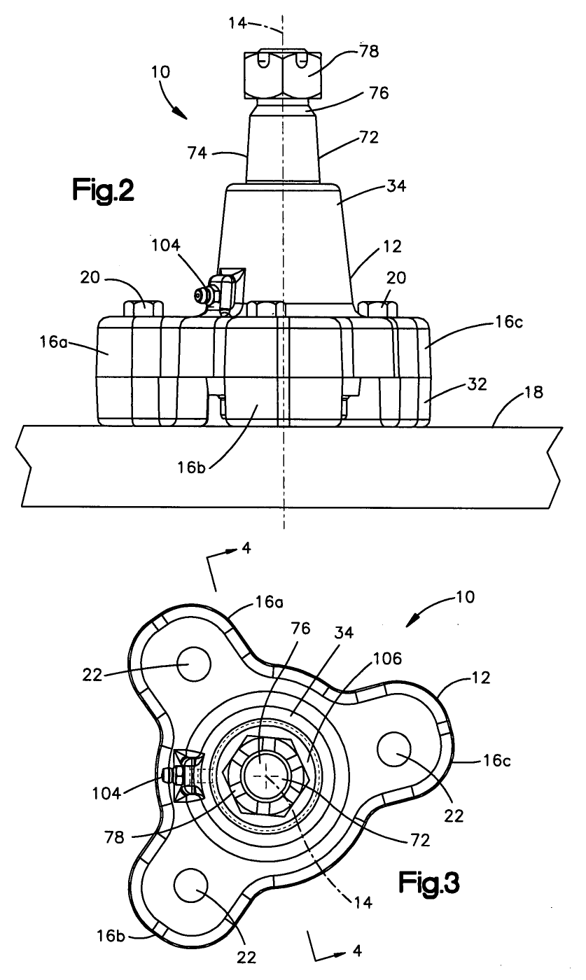

A ball joint assembly 10 constructed in accordance with an exemplary embodiment of the present invention is illustrated in FIGS. 1-5. The ball joint assembly 10 includes a housing 12 having a longitudinal axis 14. The housing 12 includes three lobes 16a-16c for attaching the housing to a frame 18 of a vehicle, as illustrated in FIG. 2. Fasteners 20 may extend through holes 22 (FIGS. 1-3) located in each of the lobes 16a-16c. The fasteners 20 may threadably engage the frame 18 of the vehicle to connect the ball joint assembly 10 to the vehicle. The housing 12 may be connected to the frame 18 in any desired manner. It is contemplated that the housing 12 may be formed as one-piece with the frame 18.

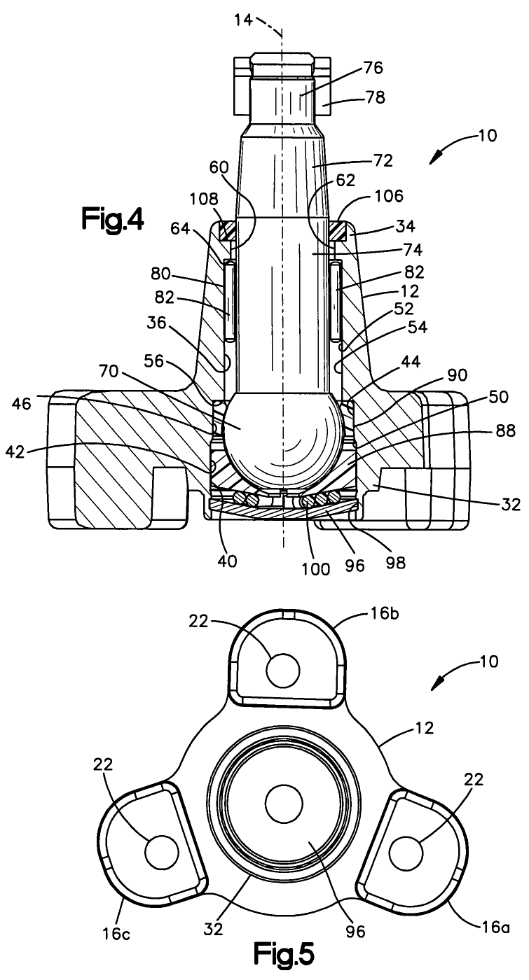

The housing 12 includes first and second axial ends 32 and 34. The first axial end 32 includes the lobes 16a-16c and may be connected to the frame 18 of the vehicle. An axially extending opening 36 (FIG. 4) extends through the housing 12 from the first axial end 32 to the second axial end 34.

A first inner cylindrical surface 40 of the housing 12 defines a first axial end portion 42 of the opening 36. The first cylindrical surface 40 has a first diameter. A second inner cylindrical surface 44 of the housing 12 defines a first intermediate portion 46 of the opening 36. The second cylindrical surface 44 has a second diameter smaller than the first diameter. A shoulder 50 extends radially inwardly from the first cylindrical surface 40 to the second cylindrical surface 44. A third inner cylindrical surface 52 of the housing 12 defines a second intermediate portion 54 of the opening 36. The third cylindrical surface 52 has a third diameter smaller than the second diameter of the second cylindrical surface 44. A shoulder 56 extends radially inwardly from the second cylindrical surface 44 to the third cylindrical surface 52. A fourth inner cylindrical surface 60 of the housing 12 defines a second axial end portion 62 of the opening 36. The fourth cylindrical surface 60 has a fourth diameter smaller than the third diameter. A shoulder 64 extends radially inwardly from the third cylindrical surface 52 to the fourth cylindrical surface 60.

The housing 12 encloses a head end portion 70 of a ball stud 72. The ball stud 72 includes a shank portion 74 which extends from the head end portion 70 and outward from the housing 12. The head end portion 70 is substantially disposed in the first axial end portion 42 and the first intermediate portion 46 of the opening 36. The shank portion 74 is disposed in the second intermediate portion 54 and the second axial end portion 62 of the opening 36.

The ball stud 72 has a threaded end portion 76 opposite the head end portion 70. The end portion 76 may be connected to a steering linkage (not shown) of the vehicle. A nut 78 threadably engages the end portion 76 to connect the ball stud 72 to the steering linkage.

A radial load bearing assembly 80, helps support the ball stud 72 for rotation relative to the housing 12. The radial load bearing assembly 80 may include a plurality of bearings 82, such as needle bearings. The bearings 82 engage the shank portion 74 and the third cylindrical surface 52 of the housing 12. The bearings 82 also engage the shoulder 64 of the housing 12. The bearing assembly 80 helps compensate for radial loads exerted on the ball stud 72.

A first annular bearing member 88 (FIG. 4) is disposed in the first axial end portion 42 of the opening 36. The first bearing member 88 engages the first cylindrical surface 40 of the housing 12 and the head end portion 70 of the ball stud 72. A annular second bearing member 90 is disposed in the first intermediate portion 46 of the opening 36. The second bearing member 90 engages the second cylindrical surface 44 of the housing 12 and the head end portion 70 of the ball stud 72. The second bearing member 90 also engages the shoulder 56 of the housing 12. The first and second bearing members 88 and 90 support the head end portion 70 for movement relative to the housing 12.

A circular metal cover 96 (FIG. 4) is fixedly secured to the housing 12. The cover 96 helps retain the ball stud 72, the bearing assembly 80, and the first and second bearing members 88 and 90 in the housing 12. The cover 96 extends into an annular groove 98 in the first axial end portion 52 of the housing 12. A spring member 100, such as a coil spring, is disposed between the cover 96 and the first bearing member 88. The spring member 100 is effective to press the first bearing member 88 against the spherical head end portion 70 of the ball stud 72. Upon the occurrence of wear in the ball joint assembly 10, the head end portion 70 of the ball stud 72 moves away from the cover 96 due to the bias of spring member 100 acting on the first bearing member 88. The spring member 100 also helps compensate for thrust loads exerted on the ball stud 72.

A port 104 (FIGS. 1-3) is formed in the housing 12 for supplying a lubricant to the ball joint assembly 10. The lubricant may lubricate the bearing assembly 80, the first and second bearing members 88 and 90 and the ball stud 72 for movement relative to each other and the housing 12. An annular seal 106 (FIG. 4) is disposed in a recess 108 in the second axial 34 of the housing 12. The seal 106 helps prevent leakage of the lubricant from the housing 12 and entry of dust and/or debris into the housing 12.

The housing 12 may be a casting, made from a metal or metal alloy such as steel, aluminum, or the like. A step machining process, such as boring or drilling, is performed to create the central opening 36 through the housing 12. The step machining process may include cutting steps of different diameters that produce the shoulders 50, 56 and 64. After the shoulders 50, 56 and 64 are formed, the bearing assembly 80 is press fit into the housing 12. The second bearing member 90 is then press fit into the housing 12. The ball stud 72 is inserted so that the head end portion 70 engages the second bearing member 90. The first bearing member 88 and the spring member 100 are inserted into the housing 12.

The cover 96 is connected to the housing 12 after the bearing assembly 80, the first and second bearing members 88 and 90, the ball stud 72, and the spring member 100 are inserted into the housing 12. The cover 96 may be made of a metal or metal alloy such as steel, aluminum, or the like. The cover 96 may be made of a material different than the housing 12. The cover 96 may be spin or friction welded into the housing 12. During the spin weld process, heat and pressure may form the groove 98 in the housing 12. It is contemplated that the first axial end 32 of the housing 12 may be roll formed during the spin weld process to form the groove 98.

Although the present invention has been described with a degree of particularity, it is the intent that the invention includes all modifications and alterations falling within the spirit and scope of the appended claims.

Having described the invention, the following is claimed:

1. A ball joint assembly comprising:
a housing;
a ball stud disposed in said housing, said ball stud having a head end portion and a shank portion;
a radial load bearing assembly engaging said shank portion to support said ball stud for movement relative to said housing.

2. The ball joint assembly as set forth in claim 1 further including a spring member biasing said ball stud in an axial direction relative to said housing.

3. The ball joint assembly as set forth in claim 1 further including first and second bearing members engaging said head end portion of said ball stud to support said ball stud for movement relative to said housing.

4. The ball joint assembly as set forth in claim 3 further including a spring member biasing said first bearing member and said ball stud in an axial direction relative to said housing.

5. The ball joint assembly as set forth in claim 4 wherein said spring member is a coil spring.

6. The ball joint assembly as set forth in claim 1 wherein said radial load bearing assembly includes a plurality of needle bearings.

7. The ball joint assembly as set forth in claim 1 wherein said housing includes an axially extending opening, said shank portion of said ball stud being disposed in said opening.

8. The ball joint assembly as set forth in claim 7 wherein said housing includes a radially extending shoulder, said radial load bearing assembly engaging said shoulder.

9. The ball joint assembly as set forth in claim 1 wherein said housing is connected to a frame of a vehicle.

10. The ball joint assembly as set forth in claim 1 further including a cover retaining said ball stud in said housing, said cover being connected to said housing by a friction weld connection.

11. The ball joint assembly as set forth in claim 10 wherein said housing is roll formed to further secure said cover to said housing.

12. The ball joint assembly as set forth in claim 10 wherein said cover extends into a groove in said housing.

13. The ball joint assembly as set forth in claim 10 wherein said cover is made from a material different than a material of said housing.
